(19) United States
(12) Patent Application Publication
(10) Pub. No.: US 2004/0090399 A1
(43) Pub. Date: May 13, 2004

(54) Multiple image display devices

(76) Inventors: Itzchak Bal-Yona, Rojh Ha'Ayin (IL); Kfir Luzzatto, Omer (IL)

Correspondence Address: Michael Neuvilth, c/o Berllin Associates, Suite 404, 2001 Jefferson Davis Hwy, Arlington, VA, 22202-3603, US

(21) Appl. No.: 10/696,032

(22) Filed: Oct. 30, 2003

Related U.S. Application Data
(60) Provisional application No. 60/424,721, filed on Nov. 8, 2002.

(51) Int. Cl. G09G 3/30

(52) U.S. Cl. 345/76

(57) ABSTRACT

The present invention is a multi-image display system that is essentially comprised of an indicia carrier on which are printed interlaced images, and a stationary electronic grating which, by means of a control circuit alternately reveals the separate images that have been combined to form the interlaced images.

### RELATED APPLICATIONS

This application claims priority from U.S. Provisional Patent Application Serial No 60/424,721 filed on Nov. 8, 2002 and which is incorporated herein in its entirely.

### FIELD OF THE INVENTION

The present invention is related to the field of display devices for advertising or information. Specifically, the present invention relates to devices that alternatively display multiple images especially for point-of-sale signs, billboards, and the like.

### BACKGROUND OF THE INVENTION

Many different systems are available today for providing multi-image displays. These include electronic systems, systems based on lenticular technology, simple mechanical systems, and hybrid systems involving elements of two or more of the above technologies.

Using presently available electronic displays, it is possible to easily and quickly change the image created on the screen and the expense of these displays is generally justified where it is desired to show large numbers of images such as in movies or videos, either prerecorded or showing “real time” events.

The principle on which the electronic displays are based is the ability of the human eye to add three or more separate small spots (sub-pixels) each composed of one of three primary colors—red, blue, and green—to form a single spot (pixel) of color. The pixel can be made to have a virtually unlimited number of colors by varying the intensity of the color of each subpixel. By building a two-dimensional array containing hundreds, thousands, or (in the largest available systems) hundreds of thousands of pixels, and controlling the color of each pixel, a color picture is created. To change the display, a control circuit which takes its input manually from, for example, a computer keyboard, or automatically from, for example, a pre-created computer program, a pre-recorded video tape, or live from a video camera is provided to control the intensity of each sub-pixel in the display.

The most common electronic display is based on the use of a cathode ray tube (CRT) such as is found in the ordinary television. A color TV employs three scanning electron beams, one for each of the primary colors. These beams respectively impinge on dots or stripes of red, green, or blue phosphors to form the color of a particular pixel. The intensity of the color of each sub-pixel is controlled by varying the energy of the electrons in the beam striking the sub-pixel as a function of time. Color TVs based on CRTs are relatively cheap but very bulky and limited in size. In addition, the light emitted by the phosphors is not extremely bright, with the result that it is difficult to see the image on the screen in daylight and especially under conditions of full sunlight.

One method devised for reducing the bulk and increasing the size of the display relative to that of a CRT based system is to use a plasma display system. In this type of display an array of cells is built behind the screen. The walls of each cell are coated with either a red, green, or blue phosphor. Three of these sub-pixels, with different color phosphors, form a pixel. The cells contain a gas that is excited by an electric current to form a plasma. Ultraviolet photons in the plasma strike the walls of the cell and are converted into visible photons. Each cell is individually addressed such that a current of variable intensity can be made to flow through it varying the color of the sub-pixel. The main advantage of such a system is that a very wide and very thin display can be constructed, also a relatively bright display results. At the present stage of development plasma displays are very expensive.

Another type of electronic display uses liquid crystals. Liquid crystal displays (LCDs) are limited in size by manufacturing difficulties. The pixels in an active-matrix LCD are dependent on thin film transistors, which frequently do not function properly. Each bad transistor results in a bad pixel, therefore the rejection rate (and consequently the cost) of LCDs increases rapidly as the size of the display is increased. In addition, LCDs do not have high enough intensity to be suitable for use in full sunlight and are relatively slow compared to the other types of electronic displays.

The type of electronic display most suitable for very large displays and especially for use in full sunlight is the so-called jumbo TV screen. In this type of display, the sub-pixels are red, green, and blue light emitting diodes (LEDs). The LEDs are arranged in pixel modules containing from three to tens of individual LEDs and typically ranging in surface area from 4 mm×4 mm to 40 mm×40 mm. The modules are arranged in a rectangular array resulting in screens ranging in size from approximately 3 m×2 m to 26 m×20 m. Each sub-pixel is individually addressed and, by varying the power to each LED, its intensity and therefore the overall color of the pixel cal be controlled. In addition to a large initial purchase cost, to a large extent the result of the cost of the diodes, LED displays require a large amount of electrical power. In order to produce enough intensity in full sunlight, the largest units consume up to 300 kw of electricity. Another difficulty with LED display units is that running them at high power greatly reduces their reliability, forcing frequent replacement of the pixel modules.

Lenticular display systems comprise two main elements: a sheet or panel, on which is created an array of lenticular lenses, and an indicia carrier, on which is printed an interlaced image. These two elements must be supported rigidly such that the distance between each lens in the array and the corresponding line of print is constant. The individual images are revealed in one of two ways: by changing of the observers viewing angle in static displays and by causing relative motion between the two elements in dynamic displays. As opposed to electronic displays, existing dynamic lenticular displays are capable of showing only a limited number of images, typically two to four, and can not show movies or real time events. To change the set of images, it is necessary to replace the indicia carrier. On the other hand, lenticular displays are relatively inexpensive when compared to electronic displays. In addition they can have very large display areas and can operate under ambient light conditions ranging from full sunlight to total darkness with the aid of either external or internal lighting. The operating and maintenance costs are minimal compared to those of electronic displays of similar size.

Multiple image display systems of various types that are based on lenticular technology have been known for many years; however, many inherent problems of the technology exist and the solution to them, especially for dynamic systems is often relatively complex and expensive. These problems and methods of overcoming them are discussed in, for example United States patents U.S. Pat. No. 6,219,948 and U.S. Pat. No. 6,226,906 and in published International Patent Application WO 02/23510 all by the same inventor hereof, the descriptions of which are incorporated herein by reference.

Methods of creating the composite print consisting of the interlaced images of the two or more images to be displayed are well known in the art. According to these methods, the original images are cut into strips and then compressed before forming the interlaced image, thus preserving all of the information that was present in the original images. In other methods of forming the interlaced image, part of the original information is deleted. Typical of this type of interlacing methods are those disclosed in U.S. Pat. No. 5,924,870 and U.S. Pat. No. 5,098,302.

A third type of display system, based on parallax barrier methods, is disclosed in the above mentioned U.S. Pat. No. 5,098,302. This system uses an interlaced image, but instead of lenticular lenses, the separate images are alternately revealed by lining up the axis of a grid with the lines of print and moving it back and forth over the interlaced image. The grid consists of alternating opaque bars and clear windows. The width of each pair consisting of a bar and a window is equal to the width of a line of print. The relative widths of the bars and windows are in a ratio that depends on the number of images, i.e. 1:1 for two images, 2:1 for three images, 3:1 for three images, etc. The multiple images are viewed either by causing relative motion between the interlaced print and the grid or by use of parallax, i.e. the observer moves his head resulting in differing viewing angles of the stationary interlaced print through the windows of the stationary grid.

Another type of multi-image display is a purely mechanical one constructed of a set of prisms that are arrayed in a planar rectangular frame with their long axes parallel to each other. The axes of each of the prisms are connected together by a suitable arrangement, such as one comprising gears or cables or a combination of these, such that all of the prisms can be rotated together. An image to be displayed is attached in strips to one face of each of the prisms, a second image to a second face, etc. such that when the set of prisms rotates a different image is displayed in the frame. Compared to the other types of display it is quite a complicated operation to replace the images to be viewed with different ones. Additionally, such a display, while comparatively simple, is rather expensive to maintain suffering from all of the problems associated with mechanical systems.

It is a purpose of this invention to provide a new type of multi-image display system that overcomes the difficulties associated with the operation of existing systems.

It is another purpose of this invention to provide a new type of multi-image display system that comprises no optical elements.

It is a further purpose of this invention to provide a new type of multi-image display system that comprises no moving parts.

Further purposes and advantages of this invention will appear as the description proceeds.

### SUMMARY OF THE INVENTION

The present invention is a multi-image display system that is essentially comprised of an indicia carrier on which are printed interlaced images, and a stationary electronic grating which, by means of a control circuit alternately reveals the separate images that have been combined to form the interlaced images.

The interlaced images are produced by any of the methods known in the art and in a preferred embodiment are printed on the indicia carrier in the form of parallel lines having equal width. In another embodiment the interlaced images are printed in the form of a two-dimensional matrix of pixels.

The electronic grating for use with the indicia carrier on which the printing comprises parallel lines is comprised of a substrate of suitable transparent material on which are printed or applied by any suitable technique, parallel arrays of rectangularly shaped strips. The strips comprise a number of superimposed layers and are the equivalent of the bars on a physical grating. Each of the strips of the grating has a width substantially equal to the width of the printed lines of the interlaced image divided by the number of separate images to be displayed and a length equal to the height of the display for vertical lines of printing, or equal to the width of the display for horizontal orientation of the printing. Each of the strips is, in its most general form, a layered structure comprising a pair of transparent electrodes separated by a layer or layers of active material. Each of the strips is physically and electrically isolated from its neighbors and individually addressed by a control circuit that is capable, on command, of creating a localized electric field, heat, or causing an electric current to flow between the electrodes of the pair. The active material in each strip has the property that, when an electrical potential is applied between the electrodes and thus causing, for example, an electric field to be created or localized heating in the volume occupied by the active material between the electrodes, its optical transparency in the visible region will be reversibly changed between an opaque state and a transparent state, or vice versa. Preferred embodiments of the invention utilize active material suitable for use with any of the technologies included in, but not limited to those of the following group: electrochromism, thermochromism, electroluminescence, liquid crystals, and suspended particles.

The multi-image display of the invention operates in the following manner: if, for example in a display having four images, every fourth pair of electrodes is connected in parallel to form a set of strips that will be activated simultaneously and the control system alternately applies an electric potential to each set such then at first the first, fifth, ninth, . . . bars become transparent while the rest are opaque, the second, sixth, tenth, . . . are made transparent followed by the third and forth sets. In this way, and in any order selected by the control system, one image at a time is revealed. The display can be illuminated by means of reflected ambient or artificial light or, in some embodiments by transmission, using artificial backlighting built into the display case and in one embodiment by the electroluminescent active material in the strips of the grating.

When electroluminescence is employed, it is the light generated by it that highlights the selected picture from the interlaced image from its back, said interlaced image being provided on a transparent substrate, thereby to display said selected image.

In the embodiment in which the interlaced image is a two dimensional matrix, the electrodes are dispersed on the surfaces of the substrate in a manner consistent with the arrangement of the interlaced image.

All the above and other characteristics and advantages of the invention will be further understood through the following illustrative and non-limitative description of preferred embodiments thereof, with reference to the appended drawings.

### BRIEF DESCRIPTION OF THE DRAWINGS

FIGS. 1 to 4 schematically illustrate a method of creating an interlaced image;

FIG. 5 shows the interlaced image created according to the method shown in FIGS. 1 to 4;

FIG. 6 shows a grating for use in creating a multi-image display;

FIGS. 7 and 8 show the two images comprising the interlaced image of FIG. 5 displayed separately with the aid of the grating of FIG. 6;

FIGS. 9 and 10 illustrate schematically a preferred embodiment of the electronic grating of the invention;

FIG. 11A shows schematically a display unit according to the invention;

FIG. 11B is a cross-sectional view showing the internal parts of the display unit of FIG. 11A;

FIG. 11C is an enlarged view of an area of FIG. 11B showing details of the structure of a preferred embodiment of the electronic grating of the invention;

FIG. 12A schematically illustrates a pixel according to another method of creating an interlaced image; and

FIG. 12B schematically illustrates a preferred embodiment of the grating of the invention and the electrical connections for use with an interlaced image created according to the method of FIG. 12A.

### DETAILED DESCRIPTION OF PREFERRED EMBODIMENTS

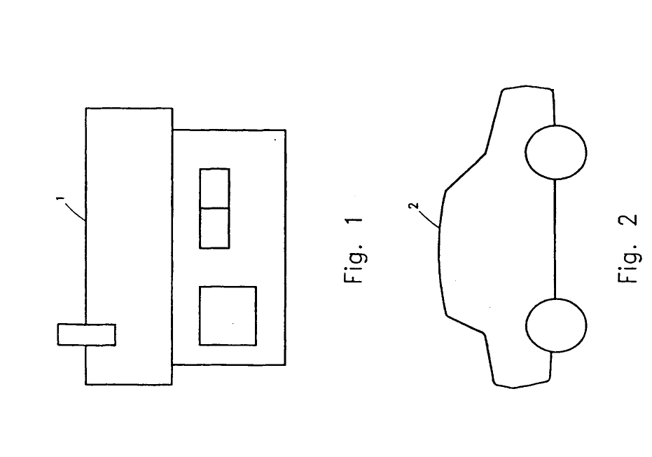

For the sake of simplicity, the basic idea of the invention is demonstrated in FIGS. 1 to 8 for a display system having two separate images. In the context of this invention the term “multi-image” means two or more images. In FIG. 1 is shown one of the images, in this case house 1, and in FIG. 2 the second image, automobile 2.

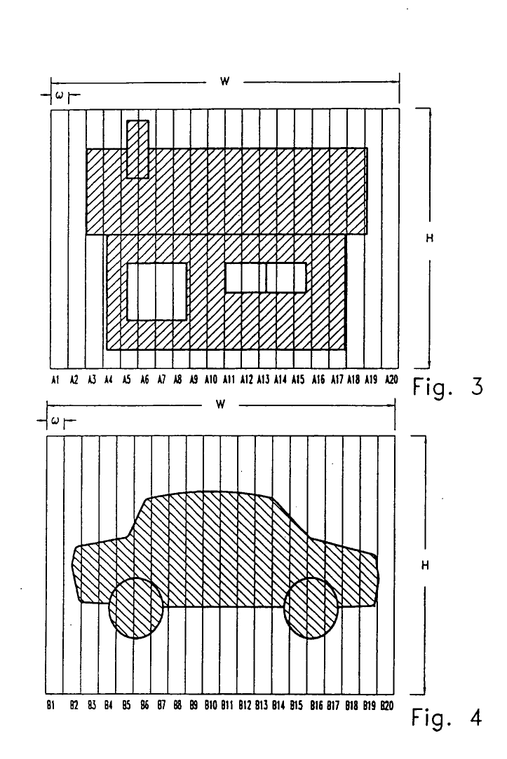

In the next step, shown in FIGS. 3 and 4, the sizes of both images are adjusted to be equal having height H and width W. Each of the images is then cut into n equal strips having height H and width w, where w=W/n. In the present example, n=20 and the strips of images 1 and 2 are labeled respectively A1-A20 and B1-B20.

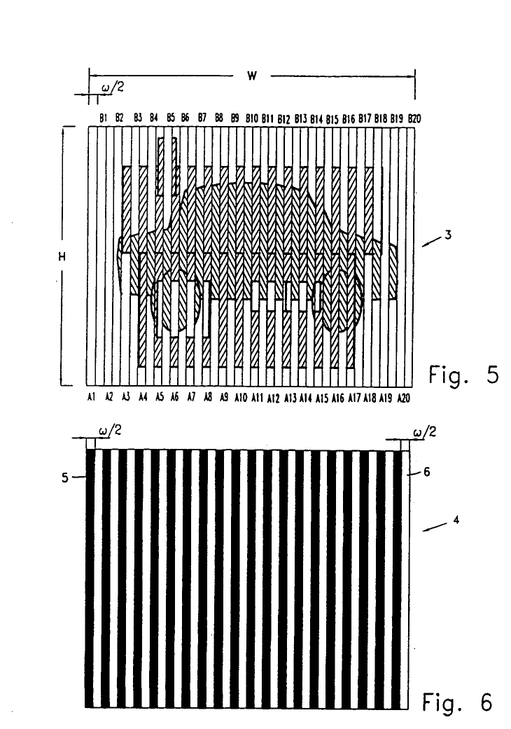

FIG. 5 illustrates the interlacing procedure. Strips A1-A20 and B1-B20 are compressed in the horizontal direction until their widths are essentially half of their original width. The forty strips of width w/2 are then arranged in the order A1, B1, A2, B2, . . . A20, B20 to form the composite interlaced image 3. Image 3 has the same size as each of the original images, i.e. height H and width W.

FIG. 6 shows a grating 4 having a size that is the same or larger than that of the composite image 3. Grating 4 is composed of alternating opaque bars 5 and transparent windows 6. All of the bars and windows have equal widths, substantially equal to w/2.

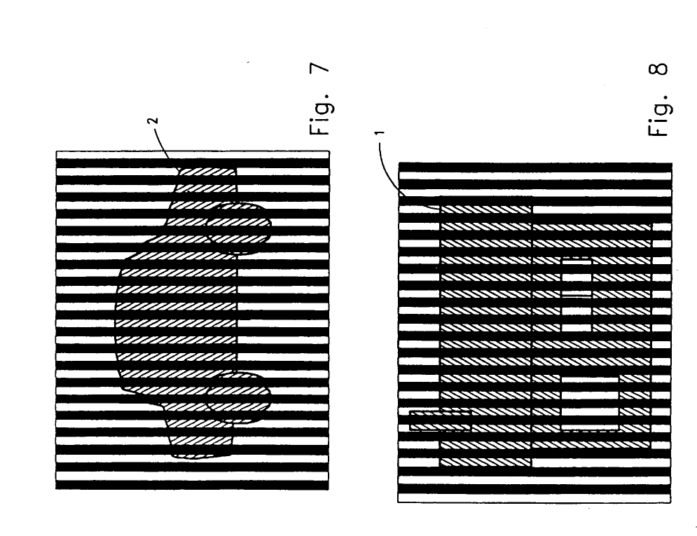

Placing grating 4 on top of the interlaced image 3 and aligning them such that the bars 5 are on top of strips A1-A20 and the windows 6 on top of strips B1-B20 results in the situation shown in FIG. 7, i.e. only the automobile 2 is visible. Horizontally sliding the grating relative to the interlaced image a distance equal to w/2 (or mw/2, where m is an integer) will expose the image of the house 1 and hide the second image. This situation is shown in FIG. 8.

According to the methods of the prior art the two separate images could be alternately viewed by physically moving either the grating or the interlaced print or both relative to each other. Alternatively, the separate images could be viewed by the parallax effect by changing the observation angle, if the grating and interlaced image were rigidly supported in separate parallel planes an appropriate distance apart. If a sufficient number of strips is provided, the human eye will make up for the missing strips, thus perceiving a whole image. Of course, as will be apparent to the skilled person, the number of strips required depends on the distance from which the image is to be viewed.

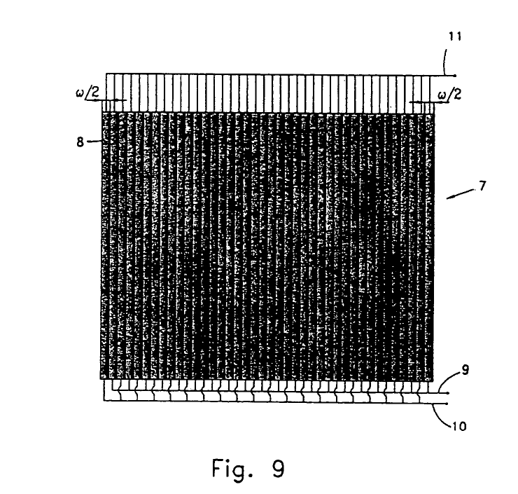

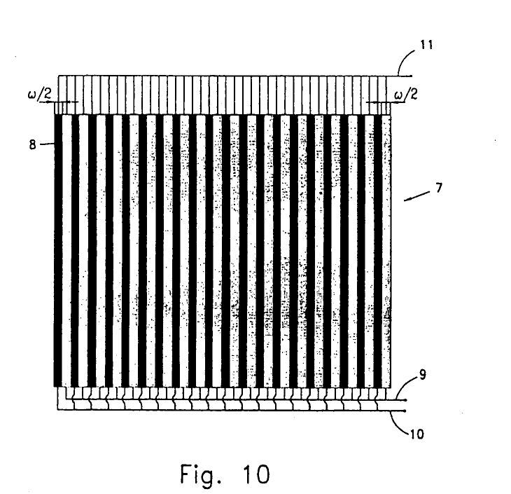

According to the present invention, it is possible to view the separate images without either using parallax effects or moving the grating and interlaced image relative to each other. Viewing of the individual images is accomplished by supplying an electronic grating comprised of a substrate on which are created an array of identical parallel strips. Each of these strips is physically and electrically isolated from its neighbors and individually addressed by a control circuit that is capable, on command, of creating a localized electric field, heat, or causing an electric current to flow between the electrodes of the pair, thus reversibly changing the optical transparency of an active material located in one or more layers that are situated in the space between the pair of electrodes in each strip. The active material has the property that the individual strip will change from transparent to opaque (or vice versa) to visible light in response to an electrical or thermal stimulus and will return to its original state when the stimulus is removed. A front view of an electronic grating 7 according to the invention is schematically shown in FIG. 9. Grating 7 is comprised of a multitude of strips, each of width w/2 where w is the width of each line of the interlaced print (FIG. 9 shows a grating designed to be used with an interlaced image comprised of two separate images, in general the strip width is w/n where n is the number of images that have been interlaced to form the combined image). The strips are printed or deposited on the surface of a transparent substrate and are physically and electrically isolated from each other. The exact technique for creating the strips of which the electronic grating is composed will depend on the nature of the active material being used as well as economic and manufacturing considerations. In any case the knowledge, equipment, and techniques necessary for the creation of the grating is readily available and known to those active in the many areas of technology that make use of, for example, printing and/or vacuum deposition techniques.

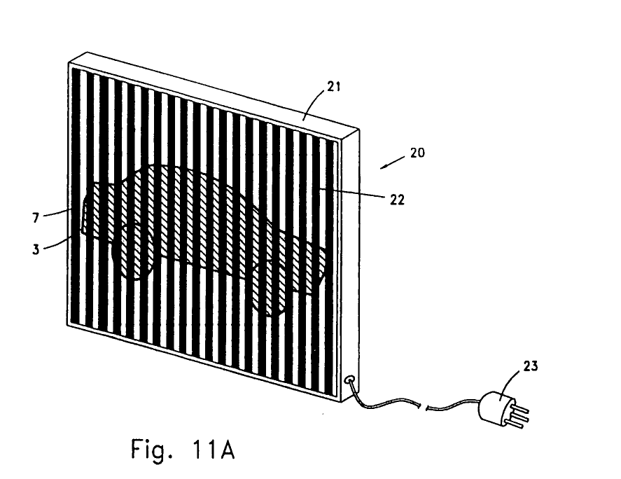

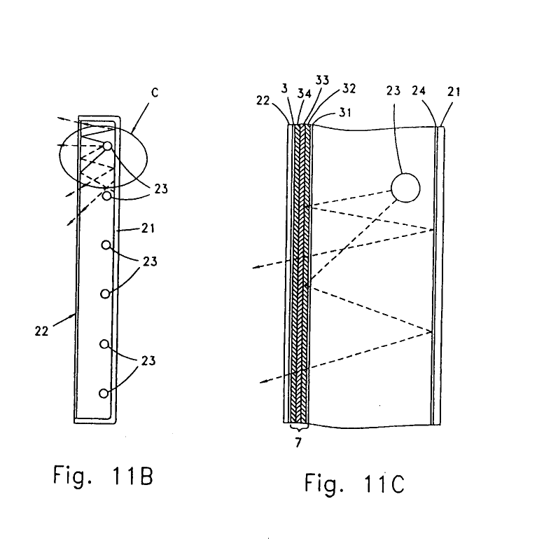

A representative strip 8 can be made up of, for example, three layers: a transparent electrode, a layer or layers associated with the active material, and a second transparent electrode. The detailed structure of the strips will be discussed hereinbelow with reference to FIG. 11C.

One of the electrodes on all of the strips is electrically connected to a common contact 11. The other electrode is connected to one of two contacts 9 or 10. With strips 1, 3, 5, etc. connected to 10 and strips 2, 4, 6, etc connected to contact 9. Thus by connecting contact 11 alternately to either contact 9 or 10 through an external control circuit an electric potential is applied providing the necessary stimulus to bring about the desired change in the optical properties of the active material in the affected strips.

In FIG. 10 is schematically shown the case in which contacts 10 and 11 are connected, i.e. a grating analogous to that of FIG. 6 has been created. Alternately connecting contacts 9 or 10 to common contact 11 using, for example, a timer will periodically change the state of alternate strips. If this electronic grating is placed over an interlaced image comprised of two images printed on an indicia carrier using lines of print of width w, then each image will be separately displayed, the images changing with the same periodicity as the change in the electric connections.

FIG. 11A shows a display device 20 according to the present invention. The display comprises a hollow box 21 on whose front face is disposed the indicia carrier on which is printed the interlaced image 3 and electronic grating 7, both protected from the external environment by a transparent layer 22. Also provided, but not shown in any of the figures, is a door or opening allowing access to the interior of the box. This arrangement allows for easy and inexpensive replacement of the indicia carrier as frequently as desired to change the content of the multi-image display. Inside the box 21 are dispersed lights, to be used for back-lighting of the images, and their electric lighting circuit, symbolically indicated by plug 23, as well as the electronic control system for the grating. The control circuit for the electronic grating is neither shown in the figures nor are embodiments described since they are conventional and familiar to the experienced person.

FIG. 11B is a cross-sectional view showing the interior of the display of FIG. 11A. In the figure are schematically shown box 21, cover 22, and lights 23 which can be, for example, a number of fluorescent tubes arranged in a parallel configuration close to the rear side of the display.

FIG. 11C is an enlarged view of area C in FIG. 11B. Numeral 22 represents the front cover of the display which is made of a sheet of transparent material such as, for example, glass or plexiglass. The cover is optional but desirable to protect the other elements of the display from damage caused by the weather or vandals. Inside the cover is the interlaced image 3 described hereinabove printed on a transparent indicia carrier, followed by electronic grating 7. It should be noted that, although the figures in this application show displays in which the print on the indicia carrier and the bars of the grating are aligned vertically, a horizontal or other alignment is, of course, also possible.

The strips of grating 7 are shown symbolically in FIG. 11C as being composed of four layers. The first layer is a transparent substrate 31, composed of a suitable material such as glass or plastic. The two electrodes 32 and 34 are made of a transparent electrically conducting material, such as an oxide or conducting polymer. Layer 33 is the layer (or in some cases layers) containing the active material. According to a preferred embodiment of the invention, the active material can be any material which has the property that its optical transparency in the visible region can be reversibly changed between an opaque state and a transparent state (or vice versa), when activated by a stimulus, e.g. electric field or localized heating, or that its luminescence can be activated by applying a stimulus, whereby to cause an image to be selectively seen from a plurality of interlaced images. Technologies associated with materials that have this property include, but are not limited to the following: electrochromism, thermochromism, electroluminescence, liquid crystals, and suspended particle devices (light valves).

Preferred embodiments of the invention utilize active materials selected from those used in the technologies mentioned hereinabove and the exact nature and structure of layer 33 depends on the requirements of the technology chosen. For example, in the embodiment of the invention employing electroluminescence, the material in the space between the electrodes is a phosphor that “glows” when an electric field is created in the space between the electrodes. The indicia carrier is placed between the electronic layer and the observer. When the electricity is applied through the control circuit, the electroluminescent material in the strips that are stimulated begin to emit light. Since the stimulated strips are positioned behind the appropriate sub image for each line of the printing on the indicia carrier, a single image is seen while the other images that comprise the interlaced image are not illuminated and therefore are not visible.

The embodiment of the electronic grating shown in FIG. 11C can be altered in many ways, depending on the application and materials employed. For example, one of the electrodes, which is at a constant potential for all of the strips can be made of a single layer that covers the entire surface area of the display. In this case, if the common electrode is that designated by numeral 32, it is possible to use it as the substrate on which the rest of the grating is created. In another example, the layer containing the active material is continuous and only those areas of this layer that are stimulated by the electrode directly covering them will undergo the desired change of optical transparency. It is to be noted that, in some embodiments of the display devices of the invention, the electronic grating can be located in front of the transparent indicia carrier as well as behind it, as described hereinabove.

The electronic grating of the invention is preferably created by using printing techniques, however any other method appropriate for the type of materials used can be employed. Examples of possible methods include, but are not limited to, spin-casting of polymers and evaporation/deposition and etching techniques used in the electronics and semiconductor industries.

An additional optional feature of the display described in FIGS. 11A to 11C is a reflecting surface 24 positioned behind the lights 23 in order to increase the intensity of the backlighting. The path of typical photons from the light source through the grating toward the observer is indicated in FIG. 11C by the broken lines (arrows). If an effort is made to make the layer containing the active material reflecting and not absorbing when it is in the opaque state, then this will contribute greatly to the intensity of the display: The reflection from the grating back into the box indicates the reflection from the back surface of layer 33 in those areas where the active material is in its opaque state

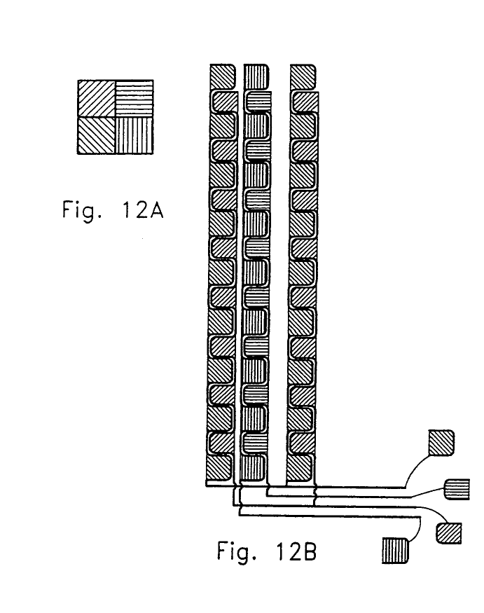

As mentioned hereinabove, there are many techniques of creating the interlaced images and suitable electronic gratings for use with these images can be created mutatis mutandis. In one method the interlaced image is printed on the indicia carrier in the form of a two-dimensional matrix of pixels, where each pixel is comprised of a number of subpixels corresponding to the number of images that have been interlaced to form the combined image. In FIG. 12A is shown a typical pixel for an interlaced image comprised of four distinct images.

The electronic grating of the invention for use with this interlaced image would then be constructed as a two-dimensional matrix whose unit cell has the same dimensions as that of the pixel of the indicia carrier. Each of the unit cells of the grating is comprised of four separate subcells corresponding to the subpixels on the indicia carrier. FIG. 12B shows a portion of one and one half rows of unit cells of the grating according to this embodiment of the invention. Also schematically shown in FIG. 12B are the electrical connections necessary to operate the grating together with the indicia carrier as a multi-image display system.

Although embodiments of the invention have been described by way of illustration, it will be understood that the invention may be carried out with many variations, modifications, and adaptations, without departing from its spirit or exceeding the scope of the claims.

1. A multi-image display system comprising a transparent indicia carrier, upon which are provided two or more interlaced images, and means for applying an external stimulus to selectively allow light to highlight parts of said indicia carrier that belong to a single image of said two or more interlaced images; whereby, upon application of said external stimulus a single image is displayed.

2. A multi-image display system comprising a stationary electronic grating and a stationary indicia carrier upon which are printed interlaced images, wherein said grating comprises individually addressable areas corresponding to the lines, pixels, or subpixels of printing on said indicia carrier, wherein each of said areas comprises a pair of electrodes, and an active material located in the space between said electrodes, said active material being such that, upon application of a stimulus to said pair of electrodes, a property of said active material changes from one state to another and, upon removal of said stimulus, said property returns to its initial state, thereby revealing or obscuring said lines, pixels, or subpixels of printing.

3. A multi-image display system according to claim 2, wherein the property is the optical transparency of said active material which, upon application of the stimulus is changed from a transparent to an opaque state, or vice versa, and upon removal of said stimulus, returns to its original state.

4. A multi-image display system according to claim 2, wherein the property is the electroluminescence of said active material which, upon application of the stimulus is changed from a luminescent to a non-luminescent state, or vice versa, and upon removal of said stimulus, returns to its original state.

5. A multi-image display system according to claim 2, wherein the stimulus is the application of an electric potential causing effects including, but not limited to, creation of a localized electric field and/or localized heating in the space between said electrodes and/or causing an electric current to flow between said electrodes.

6. A multi-image display system according to claim 2, wherein the active material exhibits one of the properties included in, but not limited to, the following group: electrochromism, thermochromism, electroluminescence; or is chosen from the group including, but not limited to: liquid crystals, and suspended particles of the types used in light valves.

7. A multi-image display system according to claim 2, wherein the printing on the indicia carrier is in the form of parallel lines and the corresponding individually addressed areas of the grating comprise an array of parallel strips.

8. A multi-image display system according to claim 2, wherein the printing on the indicia carrier is in the form of a two-dimensional matrix of pixels, wherein each pixel comprises a number of subpixels corresponding to the number of distinct images that comprise the interlaced image, and the corresponding individually addressable areas of the grating comprise a two-dimensional matrix the unit cell of which has the same dimensions as that of said pixel, wherein each unit cell is divided into separately addressable subcells corresponding to said subpixels and wherein said unit cells and said subcells are arranged with the same geometric relationship that exists between said pixels and said subpixels.

9. A multi-image display system according to claim 2, further comprising an array of lights to back-light the image.

10. A multi-image display system according to claim 2, further comprising a control circuit to apply the stimulus in a predetermined manner.

11. A multi-image display system according to claim 10, wherein the predetermined manner is applying the stimulus simultaneously to the set of all the areas of the grating corresponding to all the lines or subpixels associated with one of the distinct images, thereby displaying said distinct image.

12. A multi-image display system according to claim 11, further comprising a means for alternating, in a predetermined manner, between sets of areas of the grating, wherein each of said sets corresponds to all the lines or subpixels associated with each one of the distinct images, thereby displaying each of said distinct images individually in a predetermined sequence.
